(19) United States
(12) Patent Application Publication
(10) Pub. No.: US 2022/0134488 A1
(43) Pub. Date: May 5, 2022

(54) FLUX-CORED WELDING WIRE AND PREPARATION METHOD AND USE THEREOF, POROUS COATING AND PREPARATION METHOD THEREOF

(71) Applicant: SHANDONG JIAOTONG UNIVERSITY, Shandong (CN)

(72) Inventors: Junsheng Meng, Shandong (CN); Xiaoping Shi, Shandong (CN); Shaojun Zhang, Shandong (CN); Mingyu Wang, Shandong (CN); Bingbing Liu, Shandong (CN); Mingxuan Chen, Shandong (CN)

(21) Appl. No.: 17/058,008

(22) PCT Filed: May 11, 2020
(86) PCT No.: PCT/CN2020/089611

§ 371 Date: Nov. 23, 2020

(30) Foreign Application Priority Data
Nov. 29, 2019 (CN) 201911199136.9

(51) Int. Cl. B23K 35/02; B23K 35/30; C23C 4/131

(52) U.S. Cl. CPC B23K 35/0266; B23K 2103/02; C23C 4/131; B23K 35/3053

(57) ABSTRACT

The disclosure belongs to the technical field of surface coating, and particularly relates to a flux-cored welding wire, a preparation method and use thereof, a porous coating and a preparation method thereof. The disclosure provides a flux-cored welding wire, including a core wire and a sheath, where the core wire includes the following components by mass percentage: 15.0-30.0% of Cr, 1.5-2.5% of Si, 5.0-10.0% of Ni, 1.0-5.0% of TiH₂, and Fe as balance; and the sheath is made of steel. Test results of examples show that, the porous coating obtained by supersonic arc spraying the flux-cored welding wire provided by the disclosure has a porosity of up to 46% and a coating adhesive strength of 45 MPa, which are desired.

This application claims priority to Chinese Patent Application No. CN201911199136.9 filed to the China National Intellectual Property Administration (CNIPA) on Dec. 3, 2019 and entitled “FLUX-CORED WELDING WIRE AND PREPARATION METHOD AND USE THEREOF, POROUS COATING AND PREPARATION METHOD THEREOF”, which is incorporated herein by reference in its entirety.

### TECHNICAL FIELD

The disclosure belongs to the technical field of surface coating, and particularly relates to a flux-cored welding wire, a preparation method and use thereof, a porous coating and a preparation method thereof.

### BACKGROUND

In oil refining and petrochemical industries, a large number of heat exchangers are used. Enhancing heat transfer to improve heat exchange efficiencies of the heat exchangers to reduce energy consumption is an important way to achieve energy saving in process industries. The most effective means of enhancing heat transfer is to increase heat transfer coefficients of the heat exchangers so as to improve heat exchange. A high flux tube is a tube with a porous surface. It has many advantages such as small temperature difference in a heat exchange process of a phase change, increased number of vaporization core on a heat exchange surface, and improved heat transfer coefficient. It is widely used in petroleum, chemical and metallurgical fields and the like.

At present, methods for preparing a porous coating of the tube with a porous surface mainly include a chemical corrosion method, a flame spraying method, an electroplating method, a mechanical processing method and a sintering method. The chemical corrosion method, based on the principle of intercrystalline and pinhole corrosion, corrodes inner and outer surfaces of stainless steel in an electrolyte to obtain a porous surface layer. However, the porous layer obtained by this method has a small pore size, uneven pore distribution, and tendency of intercrystalline corrosion, reducing strength of a matrix of a material. At the same time, this method has a complex processing procedure, a long processing period, a high cost and high energy consumption. The flame spraying method uses a special flame spray gun to spray a mixture of metal powders with different particle sizes and organic polymer powders or metal powders with a low melting point as auxiliary pore formers on a matrix outside a treated and preheated metal tube at a high speed to produce certain chemical metallurgical bonds. Then, excess organic polymer powders are burned by flame. Disadvantages of this method include a thickness of a powder sintered layer which can hardly be guaranteed and problems such as safety and pollution. The electroplating method is used to plate an outer surface of a copper tube with copper powders in an electroplating solution. Or, the outer surface of the copper tube is coated with a layer of polyurethane foam and then plated with copper, where copper powders reach the outer wall of the tube through small pores of the polyurethane to form a porous layer. However, the porous layer obtained by this method has a small pore size and is not effective for media with high surface tension. Moreover, the method has a complicated processing procedure and relatively high investment and energy consumption. The mechanical processing method forms holes of different shapes on a wall of a metal tube by mechanical processing. The cost is low and the processing is simple, but the application is limited to soft metal tubes only and very small pores cannot be obtained. The sintering method is implemented by evenly coating inner and outer surfaces of a tube with an adhesive layer, covering with a certain mesh metal powders, and heating in a furnace filled with a protective gas to sinter the metal powders on the tube. Sintering and strengthening outcome is relatively desired, but the sintering process is complicated and difficult to control, and the cost is relatively high.

Therefore, it is of important industrial significance and great economic value to provide a porous coating and raw materials thereof which can ensure a high coating porosity, a high coating adhesive strength, a simple preparation process, a low cost and environmental protection without pollution.

### SUMMARY

In view of this, the disclosure aims to provide a flux-cored welding wire and a preparation method thereof. A porous coating prepared by the flux-cored welding wire of the disclosure has a high porosity and a high coating adhesive strength. Moreover, preparation and application processes of the flux-cored welding wire are simple and environmentally friendly and have a low cost. The disclosure further provides a porous coating and a preparation method thereof.

To achieve the above purpose, the disclosure provides the following technical solutions.

A flux-cored welding wire is provided, including a core wire and a sheath, where the core wire includes the following components by mass percentage:

15.0-30.0% of Cr, 1.5-2.5% of Si, 5.0-10.0% of Ni, 1.0-5.0% of TiH₂, and Fe as balance; and the sheath is made of steel.

Preferably, the flux-cored welding wire has a diameter of 2-3 mm and a filling rate of 30-40%.

Preferably, the core wire has a powder with a particle size of 20-80 μm.

A method for preparing the above flux-cored welding wire is provided, including the following steps:

mixing raw materials of the core wire, ball milling and drying in sequence to obtain filling powders;

filling the filling powders into a U-shaped groove of a U-shaped cladding material, sequentially closing the U-shaped groove and drawing a wire to obtain the flux-cored welding wire;

where the cladding material is made of steel.

Preferably, the drawing a wire is carried out at a rate of preferably 180-240 mm/s,

The disclosure further provides use of the above flux-cored welding wire or a flux-cored welding wire obtained by the above method in a field of porous coating.

The disclosure further provides a porous coating, where the porous coating is prepared by the above flux-cored welding wire or a flux-cored welding wire obtained by the above method.

The disclosure further provides a method for preparing the above porous coating, including the following steps:

providing a steel tube with a clean surface;

supersonic arc spraying the flux-cored welding wire on a surface of the steel tube with a clean surface to obtain the porous coating.

Preferably, the supersonic arc spraying is carried out at a voltage of 28-32 V with a current of 160-175 A at a pressure of 0.8-1.0 MPa.

Preferably, the supersonic arc spraying is carried out with a distance between a nozzle and a spraying plane of 150-200 mm, a wire feeding speed of 80-84 cm/min, and a nozzle moving in a radial direction of the steel tube at a rate of 10-20 mm/s; and the steel tube has an outer diameter of 19-25 mm and a rotating speed of 40-80 rpm.

The disclosure provides a flux-cored welding wire, including a core wire and a sheath, where the core wire includes the following components by mass percentage: 15.0-30.0% of Cr, 1.5-2.5% of Si, 5.0-10.0% of Ni, 1.0-5.0% of TiH₂, and Fe as balance; and the sheath is made of steel. The flux-cored welding wire provided by the disclosure contains the foaming material TiH₂, which is beneficial in forming a porous structure when a coating is prepared by supersonic arc spraying. Moreover, TiH₂ fuses well with other core wire materials, which is advantageous for uniform distribution of pores in the coating. Coating components are uniformly bonded to a matrix of a steel tube, so that an internal stress is small, which is advantageous in ensuring that a formed porous coating has desired bonding to the matrix of the steel tube.

Test results of examples show that, the porous coating obtained by supersonic arc spraying the flux-cored welding wire provided by the disclosure has a porosity of up to 46% and a coating adhesive strength of 45 MPa, which are desired.

### BRIEF DESCRIPTION OF THE DRAWINGS

FIG. 1 is a scanning electron microscopic (SEM) image of a cross-sectional morphology of the porous coating in Application Example 2 of the disclosure with magnification of 100 times; and

FIG. 2 is an SEM image of a cross-sectional morphology of the porous coating in Application Example 2 of the disclosure with magnification of 300 times.

### DETAILED DESCRIPTION

The disclosure is further described below with reference to the accompanying drawings and examples.

The disclosure provides a flux-cored welding wire, including a core wire and a sheath, where the core wire includes the following components by mass percentage:

15.0-30.0% of Cr, 1.5-2.5% of Si, 5.0-10.0% of Ni, 1.0-5.0% of TiH₂, and Fe as balance; and the sheath is made of steel.

In the disclosure, the flux-cored welding wire includes a core wire and a sheath.

Based on mass percentage, the core wire of the disclosure includes the Cr in an amount of 15.0-30.0%, preferably 16.0-25.0%, more preferably 17.0-20.0%.

Based on mass percentage, the core wire of the disclosure includes the Si in an amount of 1.5-2.5%, preferably 1.6-2.4%, more preferably 1.7-2.2%. The Si and the Cr of the disclosure are beneficial in synergistically improving wear resistance of a coating.

Based on mass percentage, the core wire of the disclosure includes the Ni in an amount of 5.0-10.0%, preferably 6-9.5%, more preferably 8-9.3%. The Ni of the disclosure is advantageous in obtaining a self-fluxing core wire.

Based on mass percentage, the core wire of the disclosure includes the TiH₂ in an amount of 1.0-5.0%, preferably 1.3-4.0%, more preferably 2.0-3.0%. The TiH₂ of the disclosure is beneficial in forming a porous structure when the coating is prepared by supersonic arc spraying. Moreover, TiH₂ fuses well with other core wire materials, which is advantageous for uniform distribution of pores in the coating. Coating components are uniformly bonded to a matrix of a steel tube, so that an internal stress is small, which is beneficial in ensuring that a formed porous coating has desired bonding to the matrix of the steel tube.

Based on mass percentage, the core wire of the disclosure includes the Fe as balance.

In the disclosure, the core wire has a powder with a particle size of preferably 20-80 μm, more preferably 25-75 μm, and further preferably 30-70 μm.

In the disclosure, the flux-cored welding wire has a diameter of preferably 2-3 mm, more preferably 2.2-2.8 mm, and further preferably 2.4-2.6 mm. In the disclosure, the flux-cored welding wire has a filling rate of preferably 30-40%, more preferably 32-38%, further preferably 34-36%.

In the disclosure, the sheath is made of steel, preferably carbon steel, and more preferably cold rolled strip steel. In an example of the disclosure, based on mass percentage, the cold rolled strip steel includes 0.009-0.018% of C, 0.007-0.025% of Si, 0.25-0.30% of Mn, 0.007-0.012% of P, 0.0005-0.008% of S and Fe as balance.

The disclosure also provides a method for preparing the flux-cored welding wire of the above technical solution, including the following steps:

mixing raw materials of the core wire, ball milling and drying in sequence to obtain filling powders;

filling the filling powders into a U-shaped groove of a U-shaped cladding material, sequentially closing the U-shaped groove and drawing a wire to obtain the flux-cored welding wire;

where the cladding material is made of steel.

The disclosure is implemented by mixing raw materials of the core wire, ball milling and drying in sequence to obtain filling powders.

In the disclosure, components of the raw materials of the core wire are the same as those of the core wire in the above technical solution, and thus are not repeated here.

The disclosure has no special limit on the mixing, and a mixing method well known to those skilled in the art can be used. In the disclosure, the ball milling is carried out for preferably 2-4 h, more preferably 2.5-3.5 h, most preferably 3 h at a rate of preferably 200-300 rpm, more preferably 220-280 rpm, most preferably 240-260 rpm. In the disclosure, the ball milling has a ball-to-material ratio of preferably (8-12):1, more preferably (9-11):1, most preferably (9.5-10.5):1. In the disclosure, the drying is carried out at preferably 100-120° C., more preferably 105-115° C., most preferably 108-113° C. for preferably 1.5-2.5 h, more preferably 1.8-2.3 h, most preferably 1.9-2.1 h.

After the filling powders are obtained, the disclosure is implemented by filling the filling powders into a U-shaped groove of a U-shaped cladding material, sequentially closing the U-shaped groove and drawing a wire to obtain the flux-cored welding wire.

In the disclosure, the U-shaped cladding material is made of steel. In the disclosure, the material of the cladding material is the same as that of the sheath in the above technical solution, and thus is not repeated here. In the disclosure, the cladding material has a thickness of preferably 0.7-0.9 mm, more preferably 0.75-0.85 mm, most preferably 0.8 mm. In the disclosure, the U-shaped cladding material is preferably obtained by roll forming the cladding material into a U shape. There is no special requirement on the roll forming, and a roll forming process known to those skilled in the art can be used. In the disclosure, a mass ratio of the filling powders to the cladding material is preferably (0.43-0.67):1, more preferably (0.5-0.65):1, most preferably (0.58-0.61):1. In the disclosure, there is no special limitation on a method of the filling, and a filling method known to those skilled in the art can be used. In the disclosure, there is no special limitation on a method of the closing the U-shaped groove as long as such a method can achieve closing of the U-shaped groove without leakage of the filling powders.

In the disclosure, the drawing a wire is carried out at a rate of preferably 180-240 mm/s, more preferably 190-230 mm/s, and most preferably 200-220 mm/s. In the disclosure, the drawing a wire is carried out with preferably a wire drawing machine.

The disclosure also provides use of the flux-cored welding wire of the above technical solution or a flux-cored welding wire prepared by the preparation method of the above technical solution in a field of porous coating. In the disclosure, the use is preferably use of the flux-cored welding wire as a raw material of a porous coating.

The disclosure also provides a porous coating prepared by the flux-cored welding wire of the above technical solution or a flux-cored welding wire prepared by the preparation method of the above technical solution. In the disclosure, the porous coating has a thickness of preferably 0.1-0.3 mm, more preferably 0.15-0.25 mm, further preferably 0.18-0.22 mm. In the disclosure, the porous coating has a porosity of preferably 14-47%, more preferably 15-46%. In the disclosure, the porous coating has an adhesive strength of preferably 23-46 MPa, more preferably 24-45 MPa.

The disclosure also provides a method for preparing the porous coating of the above technical solution, including the following steps:

providing a steel tube with a clean surface;

supersonic arc spraying the flux-cored welding wire on a surface of the steel tube with a clean surface to obtain the porous coating.

The disclosure provides a steel tube with a clean surface. The disclosure has no special limit on a material of the steel tube, and a steel tube material well known to those skilled in the art can be used. In the disclosure, the steel tube is preferably subjected to sandblasting to obtain the steel tube with a clean surface. In the disclosure, the sandblasting is carried out with a sand pellet including a material of preferably brown fused alumina and a particle size of preferably 10-25 mesh, more preferably 13-22 mesh, and further preferably 15-20 mesh. In the disclosure, the sandblasting is carried out at a pressure of preferably 0.7-0.9 MPa, more preferably 0.72-0.85 MPa, and most preferably 0.75-0.80 MPa. The disclosure has no particular limitation on duration of the sandblasting as long as stains and rusts on the surface of the steel tube can be removed.

After the steel tube with a clean surface is obtained, the disclosure is implemented by supersonic arc spraying the flux-cored welding wire on a surface of the steel tube with a clean surface to obtain the porous coating.

In the disclosure, the supersonic arc spraying is carried out at a voltage of preferably 28-32 V, more preferably 29-31 V, further preferably 29.5-30.5 V with a current of preferably 160-175 A, more preferably 163-172 A, further preferably 165-170 A at a pressure of preferably 0.8-1.0 MPa, more preferably 0.85-0.95 MPa, further preferably 0.88-0.92 MPa.

In the disclosure, the supersonic arc spraying is carried out with a distance between a nozzle and a spraying plane of preferably 150-200 mm, more preferably 160-190 mm, further preferably 170-180 mm, and a wire feeding speed of preferably 80-84 cm/min, more preferably 81-83 cm/min, further preferably 81.5-82.5 cm/min. In the disclosure, the spraying plane is preferably a tangent plane of a sprayed site on the steel tube upon spraying. In the disclosure, the steel tube has an outer diameter of preferably 19-25 mm, more preferably 20-24 mm, further preferably 21-23 mm, and a rotating speed of preferably 40-80 rpm, more preferably 45-75 rpm, further preferably 50-70 rpm. The supersonic arc spraying is carried out with a nozzle moving in a radial direction of the steel tube at a rate of preferably 10-20 mm/s, more preferably 12-18 mm/s, further preferably 14-16 mm/s.

The disclosure adopts the supersonic arc spraying to ensure that the flux-cored welding wire is evenly sprayed on a matrix of the steel tube during preparation of the porous coating, forming a uniform porous structure and ensuring bonding of the porous coating.

To further describe the disclosure, the following text describes a flux-cored welding wire, a preparation method and use thereof, a porous coating and a preparation method thereof provided by the disclosure in detail below in combination with examples, but the examples should not be interpreted as a limitation to the protection scope of the disclosure.

### Example 1

Based on a composition of 18.3 wt. % of Cr, 1.8 wt. % of Si, 8.5 wt. % of Ni, 1.5 wt. % of TiH₂ and Fe as balance, raw material powders with a particle size of 30-70 μm were put in a ball mill with a ball-to-material ratio controlled at 10:1, ball milled at 260 rpm for 3 h and kept at 110° C. for 2 h to obtain filling powders.

A piece of cold rolled strip steel was cut, cleaned and roll formed into a U shape to obtain a U-shaped cladding material.

Obtained filling powders were placed in a U-shaped groove of the U-shaped cladding material, where a mass ratio of the filling powders to the cladding material was 0.61:1. The U-shaped groove of the U-shaped cladding material was closed. Wire drawing was carried out with a wire drawing machine through a wire drawing die at a speed of 180 mm/s to reduce a diameter. A flux-cored welding wire with a diameter of 2.0 mm and a filling rate of 38% was obtained.

### Application Example 1

Sandblasting was carried out with 25 mesh sand pellets of brown fused alumina on a surface of a carbon steel tube with an outer diameter of 19 mm at a pressure of 0.7 MPa to obtain a steel tube with a clean surface.

Supersonic arc spraying equipment was used to spray the flux-cored welding wire obtained in Example 1 onto an outer surface of the resulted steel tube with a clean surface. Parameters of the spraying process were: spraying voltage of 30 V, spraying current of 170 A, spraying pressure of 0.9 MPa, spraying distance of 180 mm, wire feeding speed of 82 cm/min, rotation speed of the steel tube of 60 rpm, and moving speed of a spray gun of 15 mm/s. A porous coating with a thickness of 0.1-0.3 mm was obtained.

### Example 2

Based on a composition of 19.5 wt. % of Cr, 2.1 wt. % of Si, 9.2 wt. % of Ni, 2.0 wt. % of TiH₂ and Fe as balance, raw material powders with a particle size of 30-70 μm were put in a ball mill with a ball-to-material ratio controlled at 10:1, ball milled at 260 rpm for 3 h and kept at 110° C. for 2 h to obtain filling powders.

A piece of cold rolled strip steel was cut, cleaned and roll formed into a U shape to obtain a U-shaped cladding material.

Obtained filling powders were placed in a U-shaped groove of the U-shaped cladding material, where a mass ratio of the filling powders to the cladding material was 0.61:1. The U-shaped groove of the U-shaped cladding material was closed. Wire drawing was carried out with a wire drawing machine through a wire drawing die at a speed of 190 mm/s to reduce a diameter. A flux-cored welding wire with a diameter of 2.0 mm and a filling rate of 38% was obtained.

### Application Example 2

Sandblasting was carried out with 25 mesh sand pellets of brown fused alumina on a surface of a carbon steel tube with an outer diameter of 19 mm at a pressure of 0.7 MPa to obtain a steel tube with a clean surface.

Supersonic arc spraying equipment was used to spray the flux-cored welding wire obtained in Example 2 onto an outer surface of the resulted steel tube with a clean surface. Parameters of the spraying process were: spraying voltage of 30 V, spraying current of 170 A, spraying pressure of 0.9 MPa, spraying distance of 180 mm, wire feeding speed of 82 cm/min, rotation speed of the steel tube of 60 rpm, and moving speed of a spray gun of 15 mm/s. A porous coating with a thickness of 0.1-0.3 mm was obtained.

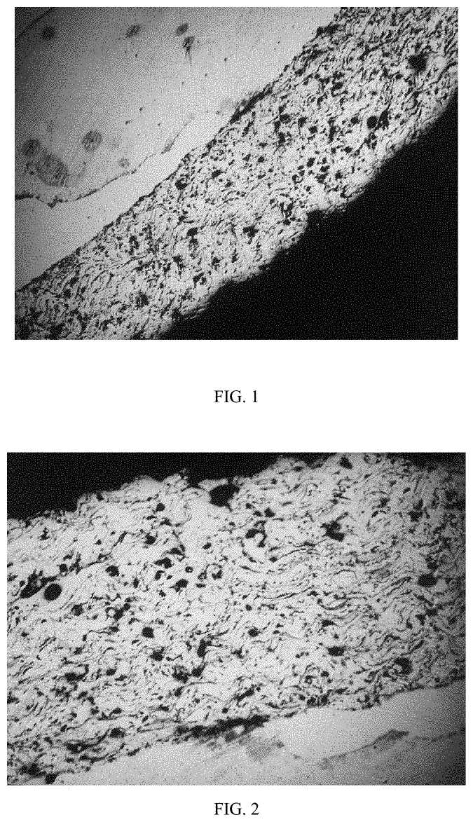

Cross-sectional morphology of the obtained porous coating was examined by a scanning electron microscope. An SEM image of the cross-sectional morphology of the obtained porous coating with magnification of 100 times was shown in FIG. 1 and the one with magnification of 300 times was shown in FIG. 2. It can be seen from FIG. 1 and FIG. 2 that, the porous coating provided by the disclosure was loose and porous inside and bonded well to the steel tube.

### Example 3

Based on a composition of 19.5 wt. % of Cr, 2.1 wt. % of Si, 9.2 wt. % of Ni, 3.0 wt. % of TiH₂ and Fe as balance, raw material powders with a particle size of 30-70 μm were put in a ball mill with a ball-to-material ratio controlled at 10:1, ball milled at 260 rpm for 3 h and kept at 110° C. for 2 h to obtain filling powders.

A piece of cold rolled strip steel was cut, cleaned and roll formed into a U shape to obtain a U-shaped cladding material.

Obtained filling powders were placed in a U-shaped groove of the U-shaped cladding material, where a mass ratio of the filling powders to the cladding material was 0.61:1. The U-shaped groove of the U-shaped cladding material was closed. Wire drawing was carried out with a wire drawing machine through a wire drawing die at a speed of 190 mm/s to reduce a diameter. A flux-cored welding wire with a diameter of 2.0 mm and a filling rate of 38% was obtained.

### Application Example 3

Sandblasting was carried out with 25 mesh sand pellets of brown fused alumina on a surface of a carbon steel tube with an outer diameter of 19 mm at a pressure of 0.7 MPa to obtain a steel tube with a clean surface.

Supersonic arc spraying equipment was used to spray the flux-cored welding wire obtained in Example 3 onto an outer surface of the resulted steel tube with a clean surface. Parameters of the spraying process were: spraying voltage of 30 V, spraying current of 170 A, spraying pressure of 0.9 MPa, spraying distance of 180 mm, wire feeding speed of 82 cm/min, rotation speed of the steel tube of 60 rpm, and moving speed of a spray gun of 15 mm/s. A porous coating with a thickness of 0.1-0.3 mm was obtained.

The IQmaterial image analysis software was used to measure porosity of the porous coatings obtained in Application examples 1-3 based on a gray level method. Results were shown in Table 1. According to standards in GB/T8642-2002 entitled “Thermal spraying—Determination of tensile adhesive strength”, adhesive strength of the porous coatings obtained in Application Examples 1-3 were tested with results shown in Table 1.

TABLE 1
Test results of porous coatings obtained in Application Examples 1-3

| | Porosity (%) | Adhesive strength/MPa |
|---|---|---|
| Application Example 1 | 15-20 | 32-45 |
| Application Example 2 | 28-36 | 28-41 |
| Application Example 3 | 35-46 | 24-34 |

It can be seen from Table 1 that, the porous coatings provided by the disclosure had a high porosity of 15-46% and an adhesive strength of up to 24-45 MPa, showing excellent bonding to the matrix of the steel tube.

The flux-cored welding wire provided by the disclosure had a simple preparation process. The porous coating provided by the disclosure had a simple preparation process with a low cost, and had features of high hardness, excellent adhesive strength and relatively high porosity. The disclosure provided a new approach for preparation of high flux tubes and had desired industrial application value.

The above description of the examples is intended to help understand the method and core idea of the disclosure only. It should be noted that, several improvements and modifications may be made by persons of ordinary skill in the art without departing from the principle of the disclosure, and these improvements and modifications should also be considered within the protection scope of the disclosure. Various modifications to these examples are readily apparent to persons skilled in the art, and the generic principles defined herein may be practiced in other examples without departing from the spirit or scope of the disclosure. Thus, the disclosure is not limited to the examples shown herein but falls within the widest scope consistent with the principles and novel features disclosed herein.

1-10. (canceled)

11. A flux-cored welding wire, comprising a core wire and a sheath, wherein the core wire comprises the following components by mass percentage:
15.0-30.0% of Cr, 1.5-2.5% of Si, 5.0-10.0% of Ni, 1.0-5.0% of TiH₂, and Fe as balance; and
the sheath is made of steel.

12. The flux-cored welding wire according to claim 11, wherein the flux-cored welding wire has a diameter of 2-3 mm and a filling rate of 30-40%.

13. The flux-cored welding wire according to claim 11, wherein the core wire has a powder with a particle size of 20-80 μm.

14. A method for preparing the flux-cored welding wire according to claim 11, comprising the following steps:
mixing raw materials of the core wire, ball milling and drying in sequence to obtain filling powders;
filling the filling powders into a U-shaped groove of a U-shaped cladding material, sequentially closing the U-shaped groove and drawing a wire to obtain the flux-cored welding wire;
wherein the cladding material is made of steel.

15. A method for preparing the flux-cored welding wire according to claim 12, comprising the following steps:
mixing raw materials of the core wire, ball milling and drying in sequence to obtain filling powders;
filling the filling powders into a U-shaped groove of a U-shaped cladding material, sequentially closing the U-shaped groove and drawing a wire to obtain the flux-cored welding wire;
wherein the cladding material is made of steel.

16. A method for preparing the flux-cored welding wire according to claim 13, comprising the following steps:
mixing raw materials of the core wire, ball milling and drying in sequence to obtain filling powders;
filling the filling powders into a U-shaped groove of a U-shaped cladding material, sequentially closing the U-shaped groove and drawing a wire to obtain the flux-cored welding wire;
wherein the cladding material is made of steel.

17. The method according to claim 14, wherein the drawing a wire is carried out at a rate of preferably 180-240 mm/s,

18. The method according to claim 15, wherein the drawing a wire is carried out at a rate of preferably 180-240 mm/s,

19. The method according to claim 16, wherein the drawing a wire is carried out at a rate of preferably 180-240 mm/s,

20. A porous coating, wherein the porous coating is prepared by the flux-cored welding wire according to claim 11.

21. A porous coating, wherein the porous coating is prepared by the flux-cored welding wire according to claim 12.

22. A porous coating, wherein the porous coating is prepared by the flux-cored welding wire according to claim 13.

23. A porous coating, wherein the porous coating is prepared by a flux-cored welding wire obtained by the method according to claim 14.

24. A porous coating, wherein the porous coating is prepared by a flux-cored welding wire obtained by the method according to claim 15.

25. A porous coating, wherein the porous coating is prepared by a flux-cored welding wire obtained by the method according to claim 16.

26. A porous coating, wherein the porous coating is prepared by a flux-cored welding wire obtained by the method according to claim 17.

27. A porous coating, wherein the porous coating is prepared by a flux-cored welding wire obtained by the method according to claim 18.

28. A porous coating, wherein the porous coating is prepared by a flux-cored welding wire obtained by the method according to claim 19.
